(19) United States
(12) Patent Application Publication
(10) Pub. No.: US 2008/0010321 A1
(43) Pub. Date: Jan. 10, 2008

(54) METHOD AND SYSTEM FOR COHERENT DATA CORRECTNESS CHECKING USING A GLOBAL VISIBILITY AND PERSISTENT MEMORY MODEL

(75) Inventors: Christopher T. Phan, Rochester, MN (US); Jamie R. Kuesel, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/425,239

(22) Filed: Jun. 20, 2006

(51) Int. Cl. G06F 17/30; G06F 12/00

(52) U.S. Cl. 707/201

(57) ABSTRACT

Exemplary embodiments include a system for coherent data correctness checking including: an address manager in operable communication with a processor, a DRAM model, and a IO bus; and a persistent memory model in operable communication with the processor, the IO bus, and a unit monitor checker, the persistent memory model operable for storing data information that can be compared with a data stored in an internal cache of the processor or the DRAM, wherein the unit monitor checker tracks memory operations throughout the system.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

The present disclosure relates generally to caching methods and systems, and more specifically to a method and system for coherent data correctness checking using a global visibility and persistent memory model.

2. Description of the Related Art

In personal computer systems (PCs), a CPU and a memory (such as a DRAM) are interconnected through a bus. Each device acts as a master device (bus master) to access the memory in which data is stored. While such memories (system memories) configured as DRAMs have a large storage capacity, they provide slower access performance. In order to achieve faster access to frequently used data, a CPU uses a cache memory (hereinafter “cache”) implemented by a memory such as an SRAM. Although a cache has a smaller storage capacity than a DRAM system memory, it can provide faster access than DRAM system memory.

In a multiprocessor system, the same data may be shared and separately cached by different processors. To address the problem of multiple processors modifying the same data in local caches without notifying the other, various cache states have been defined and included into the cache organization to support different cache coherency protocols in snooping mechanisms. While many different cache coherency states have been defined for different multi-processor systems, the MESI protocol states remain very popular basic cache coherency states.

Consider the case where a memory controller and IO Bridge Chip's coherency protocol is being verified. An example would be a processor read which could either be serviced from the memory controller's internal cache or from local memory, such as DRAM, depending upon the cache state of the coherent read address. Currently, there is no reliable method to check for the correctness of the coherent data to validate the coherency protocol.

### SUMMARY

The shortcomings of the prior art are overcome and additional advantages are provided through the provision of test generation methods.

Exemplary embodiments include a system for coherent data correctness checking including: an address manager in operable communication with a processor, a DRAM model, and a IO bus; and a persistent memory model in operable communication with the processor, the IO bus, and a unit monitor checker, the persistent memory model operable for storing data information that can be compared with a data stored in an internal cache of the processor or the DRAM, wherein the unit monitor checker tracks memory operations throughout the system.

Exemplary embodiments also include a method for coherent data correctness checking using a persistent memory model including: storing a data in a persistent memory model; checking the correctness of an internal data; comparing the data in the persistent memory model with the internal data during data read operations; and updating the internal data during a data write operations.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that provides a reliable method to check for the correctness of the coherent data to validate the coherency protocol.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a functional diagram of a system for coherent data correctness checking including a persistent memory model in accordance with exemplary embodiments;

FIG. 2 illustrates a flowchart diagram of a method for coherent data correctness checking including a persistent memory model in accordance with exemplary embodiments; and

FIG. 3 illustrates a flowchart diagram of a method for coherent data correctness checking using a persistent memory model in accordance with exemplary embodiments.

The detailed description explains the preferred embodiments of the invention, together with advantages and features, by way of example with reference to the drawings.

### DETAILED DESCRIPTION

Referring now to the Figures for the purpose of illustration, it is to be understood that standard components or features that are within the purview of an artisan of ordinary skill and do not contribute to the understanding of the various exemplary embodiments are omitted from the Figures to enhance clarity.

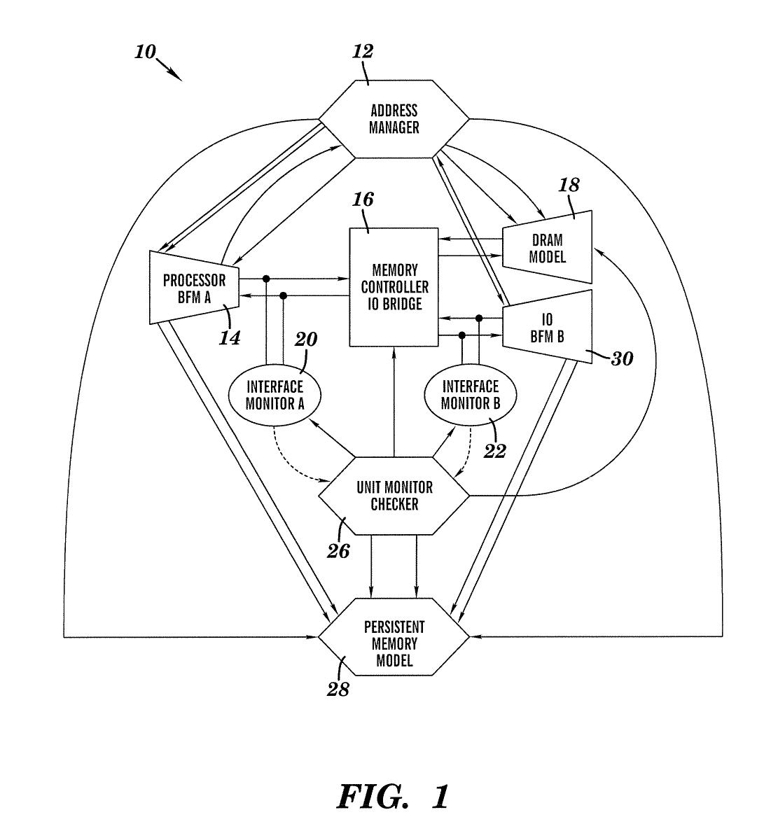

FIG. 1 illustrates a functional diagram of a system 10 for coherent data correctness checking using a persistent memory model in accordance with exemplary embodiments. The system 10 includes an address manager 12, a processor 14, a memory controller 16, a DRAM 18, an interface 20, a first interface monitor 22, a second interface monitor 24, a unit monitor checker 26, a persistent memory model 28, and an IO bus 30. The address manager 12 is in operable communication with the processor 14, the DRAM 18, and the IO bus 30. The memory controller 16 is in operable communication with the processor 14, the DRAM 18, the IO bus 30, and the unit monitor checker 26. The interface monitor 20 and the second interface monitor 22 monitor the communication between the memory controller 16 and the processor 14 and 10 bus 30 respectively. The persistent memory model 28 is in operable communication with the address manager 12, the processor 14, the IO bus 30, and the unit monitor checker 26. In exemplary embodiments, the persistent memory model 28 stores data information that can be used for comparison with the data stored in internal cache of the processor 14 or the DRAM 18.

The point where data from the persistent memory model 28 is being used to verify the correctness of read response data from the processor 14 or persistent data is referenced by processor 14 or 10 bus functional models. The use of global visibility with a persistent memory model 28 takes advantage of the fact that the bus coherent operation now has the exclusive ownership of the coherent address with the acknowledgement of the whole system. Accordingly, the data in the persistent memory model 28 can be updated for writes and compared against the data response for reads. Additionally, the use of global visibility with a persistent memory model 28 ensures that no matter where the actual data resides for a given coherent address, there will be only one valid value for the data at that address.

In exemplary embodiments, the unit monitor checker 26 tracks the coherent memory operation from the external bus interface through the internal hardware logic to the point where the operation becomes globally visible to the whole system. At this point, the processor store data can be copied into the persistent memory model 28. For processor reads, the content of the persistent memory model 28 can be saved to compare it against the read data response later.

In exemplary embodiments the persistent memory model 28 operates in conjunction with the global visibility point for different types of coherent memory operations including persistent data update operations and persistent data reference operations.

In one exemplary embodiment, specific sequences should be followed for persistent data update operations. For example, during a processor read operation the persistent memory address should already be preloaded before the read. In another example, during a processor internal store the persistent data is updated with the internal store data. During a processor write-back the persistent data should already be updated before the write-back. Additionally, during an IO DMA load the persistent memory address should already be preloaded before the load. Further, during an IO DMA store the persistent data will be updated with the DMA store data when the store becomes globally visible. The global visibility point indicates the cache line ownership for the store address was obtained by hardware.

In another exemplary embodiment, specific sequences should be followed for persistent data reference operations. For example, during a processor read command the persistent data will be compared against the actual read response data. In another example, during a processor write-back command the persistent data will be compared against the actual write-back data. During an IO DMA load command the persistent data will be saved when the load becomes globally visible. The global visibility point indicates the cache line ownership for the load address was obtained by hardware. This persistent data snapshot will be used later for comparison against the actual DMA Read Response Data on the IO interface. Further, during an IO DMA store command the persistent data will be compared against the actual Store Data on the processor interface.

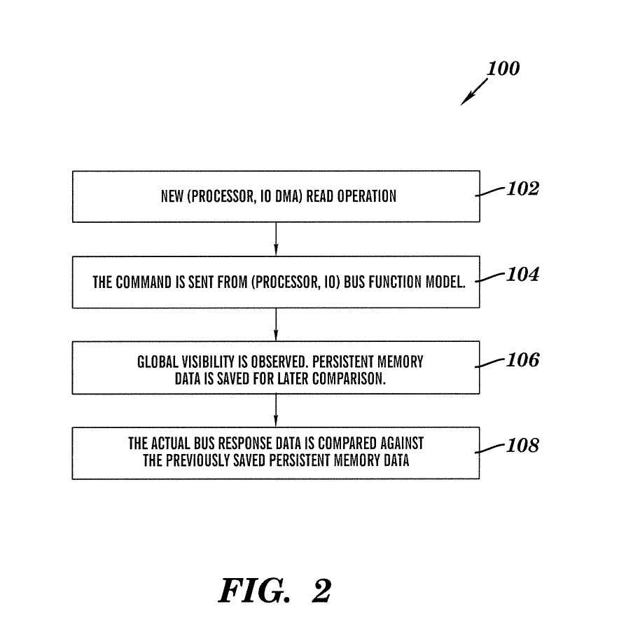

Referring now to FIG. 2, a flow chart for a method for coherent data correctness checking using a persistent memory model is depicted generally as 100. The method 100 includes executing a processor operation, such as a processor read, as shown at process step 102. The method 100 also includes transmitting the command corresponding to the processor operation through the internal hardware, as shown at process step 104. Furthermore, the method 100 proceeds to process step 106 and observes a global visibility point and the persistent memory data is saved for later comparison. The method 100 concludes by comparing the actual bus response data to the previously saved persistent memory data, as shown at process step 108. Additionally, the method may also include preloading an address corresponding to data in the persistent memory model before a processor read operation.

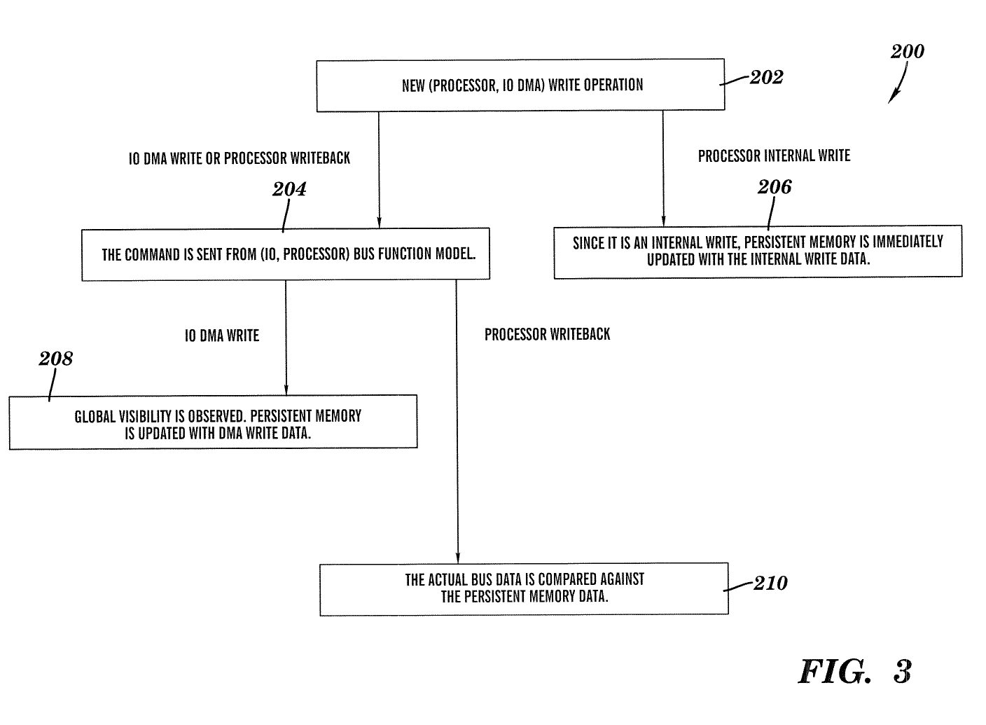

Turning now to FIG. 3, a flow chart for a method for coherent data correctness checking using a persistent memory model is depicted generally as 200. The method 200 includes executing a processor operation, such as a processor write, as shown at process step 202. If the processor operation is a IO DMA write or processor writeback the method 200 proceeds to method step 204. If the processor operation is a processor internal write the method 200 proceeds to method step 206. At method step 206, the method 200 the persistent memory is immediately updated with the internal write data. At method step 204, the command, or processor operation, is sent from (IO, Processor) bus function model and the method 200 proceeds to method step 208 or method step 210 depending upon the processor operation. At method step 208, a global visibility point is observed, the persistent memory is updated with DMA write data, and the method proceeds to method step 210. At method step 210, the actual bus write data is compared against the persistent memory data.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for coherent data correctness checking comprising:
an address manager in operable communication with a processor, a DRAM model, and a IO bus; and
a persistent memory model in operable communication with the processor, the IO bus, and a unit monitor checker,
a global visibility point operable for determining when to update or reference the persistent memory model, the persistent memory model operable for storing data information that can be compared with a data stored in an internal cache of the processor or the DRAM, wherein the unit monitor checker tracks memory operations throughout the system.

2. The system of claim 1, wherein an address corresponding to data in the persistent memory model is preloaded or stored before a processor read operation and the global visibility point is tracked by the unit monitor checker.

3. The system of claim 2, wherein for a processor internal store the persistent data model is updated with an internal store data.

4. The system of claim 3, wherein the persistent data model is updated before a processor write-back operation.

5. A method for coherent data correctness checking using a persistent memory model comprising:
storing a data in a persistent memory model;
checking the correctness of an internal data;
comparing the data in the persistent memory model with the internal data during data read operations; and
updating the internal data during a data write operations.

6. The method of claim 5, further comprising preloading an address corresponding to data in the persistent memory model before a processor read operation.
